(19) United States
(12) Patent Application Publication
(10) Pub. No.: US 2009/0161078 A1
(43) Pub. Date: Jun. 25, 2009

(54) Projector, and mobile device and computer device having the same

(75) Inventors: Spencer Wu, Taipei (TW); Ted Teng, Taipei (TW); Aaron Chen, Taipei (TW); Kevin Kao, Taipei (TW); Ian Liu, Taipei (TW); Aska Wang, Taipei (TW); Ahern Tai, Taipei (TW); Zeno Lee, Taipei (TW); William Chen, Taipei (TW)

Correspondence Address: REED SMITH LLP;ATTN: Juan Carlos A. Marquez, Suite 1400, 3110 Fairview Park Drive, Falls Church, VA, 22042, US

(73) Assignee: Oculon Optoelectronics, Inc.

(21) Appl. No.: 12/003,350

(22) Filed: Dec. 21, 2007

(51) Int. Cl. G03B 21/16

(52) U.S. Cl. 353/57; 353/52

(57) ABSTRACT

A projector includes a housing, an optical unit, and a heat transfer module. The housing is made of a material with high thermal conductivity having a window. The optical unit is accommodated in the housing and further includes a light source, a panel, and a projection lens. The light source provides a light. The panel modulates the light. The projection lens projects the modulated light to leave the window. The heat transfer module is accommodated in the housing and connected the optical unit and the housing to transfer heat from the optical unit to the housing. Particularly, the projector is a cooling-fan saved projector. In addition, the projector further comprises a computer card adapter and a computer card inserted into the computer card adapter.

### FIELD OF THE INVENTION

The present invention is related to a projector, a mobile device, and a computer device, and more particularly to a cooling-fan saved projector capable of presenting image/video data from an external computer card.

### BACKGROUND OF THE INVENTION

In general, the projector presents a bigger view of images and content. And a LCD projector with a panel can provide images of better quality. But it needs a high-power light source for illuminating the panel and causes a lot of heat. The temperature of the light source may increase and cause the projector to break down. So heat transfer or cooling is required to prevent this kind of problem.

Conventionally, heat transfer or cooling is achieved by utilizing at least one cooling-fan. Unfortunately, the cooling-fan generates noise and affects the performance of the projector.

With the cooling-fan, the projector usually has a big size and is inconvenient for mobile use. Therefore the usage of a conventional projector is limited to some situations and the user cannot utilize the projector anything anywhere.

Therefore it is desirable to improve the drawback of the conventional projectors. It is even more desirable to have a portable and a cooling-fan saved projector capable of presenting video data from an external computer card.

### SUMMARY OF THE INVENTION

The present invention is to provide a projector that includes housing, an optical unit, a heat transfer module, and a control circuit. Particularly, it provides a cooling-fan saved projector capable of presenting video data from an external computer card.

One aspect of the present invention is to reduce heat generated from the optical unit of the projector via the heat transfer module. The heat transfer module is accommodated in the housing of the projector. The heat is transferred from the optical unit to the housing via the heat transfer module. Furthermore, the heat transfer module includes a heat sink and a heat pipe. Particularly, the projector can work longer when the heat transfer module is used.

Another aspect of the present invention is to provide a computer card adapter and a computer card inserted into the computer card adapter in a projector. The control circuit of the projector processes signals of DVB-T/H, MP4, 1-Seg, RF Tx/Rx, DVD, or AV IN/OUT from the computer card. And the projector projects data according to the signals from the computer card when inserted into the computer card adapter.

In one embodiment, disclosed is a projector including a housing, an optical unit, and a heat transfer module. The housing is made of a material with high thermal conductivity having a window. The optical unit is accommodated in the housing. In addition, the heat transfer module is accommodated between the optical unit and the housing and transfers a heat from the optical unit to the housing. One embodiment of the projector disclosed a housing, an optical unit and a heat transfer module. The housing has a high thermal conductivity with a window and accommodates the optical unit and the heat transfer module in between the two for heat transfers.

In another embodiment, disclosed is a projector further including a control circuit, a computer card adapter, and a computer card insertable into the computer card adapter. The computer card adapter may be disposed inside or outside the housing. The control circuit processes signals of DVB-T/H, MP4, 1-Seg, RF Tx/Rx, DVD, or AV IN/OUT from the computer card in order to control the optical unit. Particularly, the computer card adapter is connected to the control via a wireless.

Another embodiment of the projector discloses a control circuit, a computer card adaptor and a computer card for insertion. The computer card adaptor may be on the inside or outside of the housing. The control circuit processes signals of DVB-T/H, MP4, 1-Seg, RF Tx/Rx, DVD, or AV IN/OUT from the computer card to control the optical unit. The computer card adaptor is connected to the control circuit wirelessly.

Another embodiment of the projector discloses a mobile device including a housing, an optical unit, a heat transfer module, a communication circuit, and a control circuit. The communication circuit receives data from a remote station via wireless communication. The control circuit is connected to the communication circuit for controlling a panel of the optical unit to modulate light in order to present the data.

Another embodiment of the projector discloses a computer device including a housing, an optical unit, a heat transfer module, a memory, and a control circuit. The memory stores a data input by the user. The control circuit is connected to the memory for controlling the panel of the optical unit to modulate the light in order to present the data.

The foregoing and other features of the invention will be apparent from the following detailed description of embodiment of the invention.

### BRIEF DESCRIPTION OF THE DRAWINGS

The present invention is illustrated by way of example and not intended to be limited by the figures of the accompanying drawing, in which like notations indicate similar elements.

FIG. 1a illustrates a projector structure according to an embodiment of the present invention;

FIG. 1b illustrates a heat transfer module according to the embodiment of the present invention;

FIGS. 2a-2d illustrate a projector structure according to one embodiment of the present invention;

FIG. 3 illustrates a projector according to another embodiment of the present invention;

FIG. 4 illustrates a mobile device having an embedded projector according to the embodiment of the present invention; and

FIG. 5 illustrates a computer device having an embedded projector according to the embodiment of the present invention.

### DETAILED DESCRIPTION OF THE INVENTION

As follows, the invention has been described with reference to specific embodiments. However, it will be appreciated that various modifications and changes can be made without departing from the scope of the present invention. The specification and figures are to be regarded in an illustrative manner, rather than a restrictive one, and all such modifications are intended to be included within the scope of present invention. Benefits, other advantages, and solutions to problems have been described above with regard to specific embodiments.

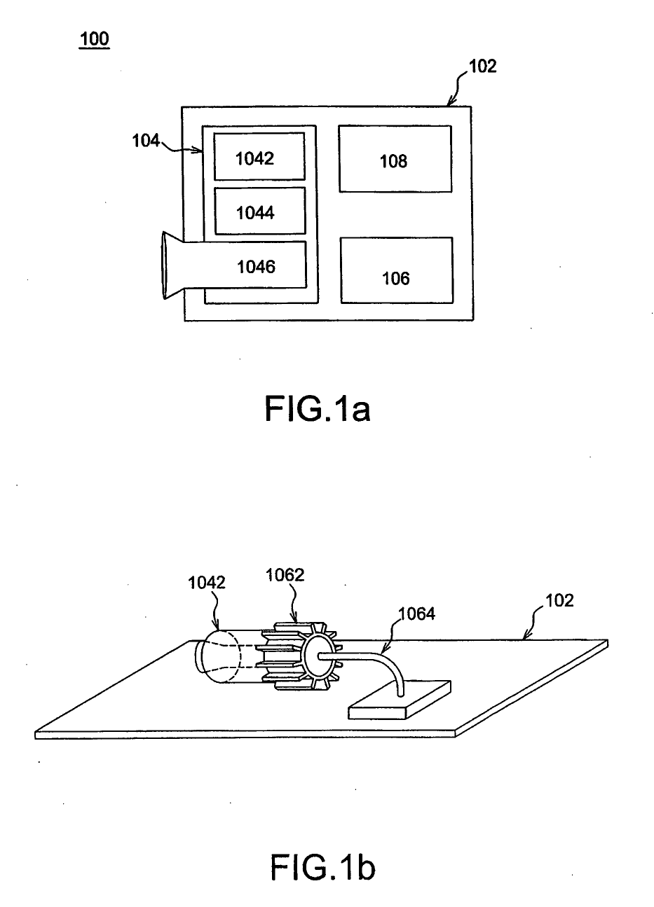

FIG. 1a is a schematic block diagram illustrating a projector according to one embodiment of the present invention. In this embodiment, the projector 100 includes a housing 102, an optical unit 104, a heat transfer module 106 and a control circuit 108. The housing 102 is made of a material with high thermal conductivity and has a window 3128 (as shown below). The optical unit 104 is accommodated in the housing 102 and further includes a light source 1042, a panel 1044, and a projector lens 1046. The light source 1042 generates light for the panel 1044. The control circuit 108 controls the panel 1044 to modulate the light for forming the image to be viewed. The projection lens 1406 then projects the modulated light to leave the window 3128 and present the image/video to the user. The heat transfer module 106 is also accommodated in the housing 102 and connected between the optical unit 104 and the housing for transferring heat from the optical unit 104 to the housing 102.

The light source 1042 of the optical unit 104 will generate heat when the projector 100 operates. If not handled well, the generated heat will cause the optical unit 104 and the projector to burn down. As a result, in the projector 100, the heat is designed to be transferred to the housing 102 made of a material with high thermal conductivity, for example, metal, and then dissipated into the environment. In this embodiment, the heat transfer module 106 is to replace a conventional cooling-fan, so the projector 100 becomes a cooling-fan saved projector. The heat is transferred by the heat transfer module from the optical unit to the housing and is then radiated out.

The light source 1042 consists of the light emitting diodes (LED), organic light emitting diodes (OLED), or lamps. The panel 1044 consists of AMLCD or LCOS. In an example, the light source 1042 and the panel 1044 may be integrated as an OLED device, which saves the backlight. The projector lens 1046 includes the polarizing beam splitter and a plurality of lens (as shown below) for projecting the modulated light to leave the window. The projector lens 1046 is arranged to determine the sizes of the projection.

FIG. 1b is a schematic diagram illustrating the heat transfer module 106 according to one embodiment of the present invention. In this embodiment, the heat transfer module 106 connects the light source 1042 and the housing 102 to transfer the heat directly from the light source 1042 to the housing 102. Moreover, the heat transfer module 106 includes a heat sink 1062 and a heat pipe 1064. The heat sink 1062 has a shape covered with the entire or a part of the rear of the light source 1042. The heat pipe 1064 is connected between the heat sink 1062 and the housing 102. For example, the material within the heat pipe 1064 may be liquid, gas or solid.

Particularly, the heat is transferred to the bottom of the housing 102 that is connected to the heat transfer module 106. It may be appreciated that the heat is transferred not only via the heat pipe 1064 but also via the heat sink 1062 directly. The heat sink 1062 may directly transfer the heat to the housing 102 without via the heat pipe 1064. The heat is transferred to the housing by the heat transfer module 106. it may be appreciated that the heat is not only transferred by the heat pipe 1064 but also by the heat sink 1062 alone.

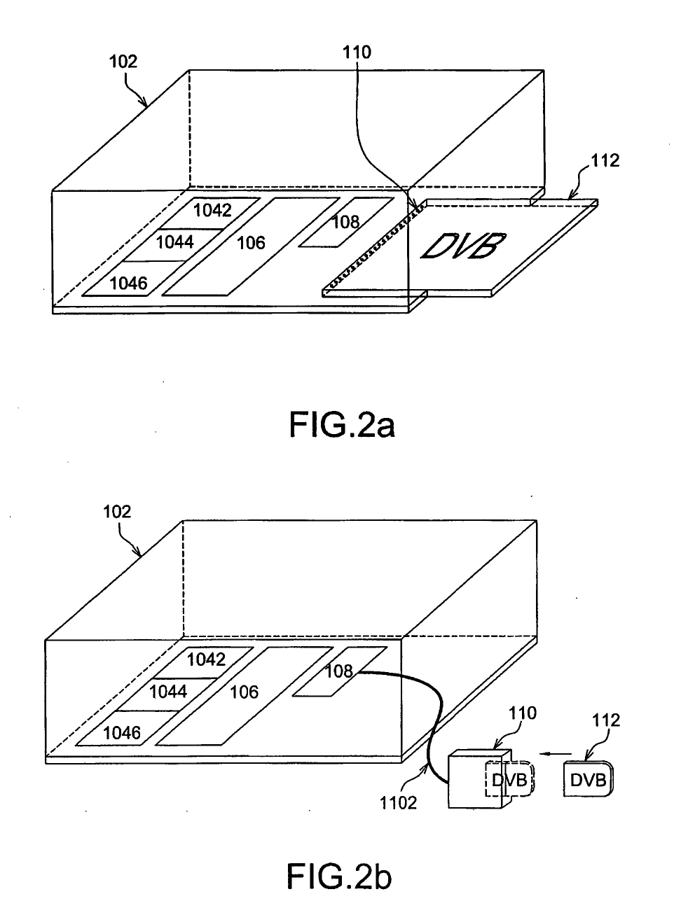

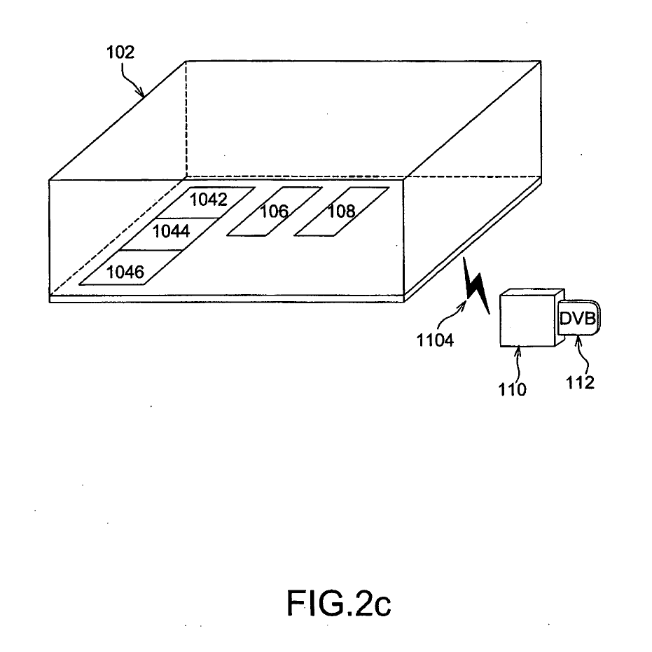

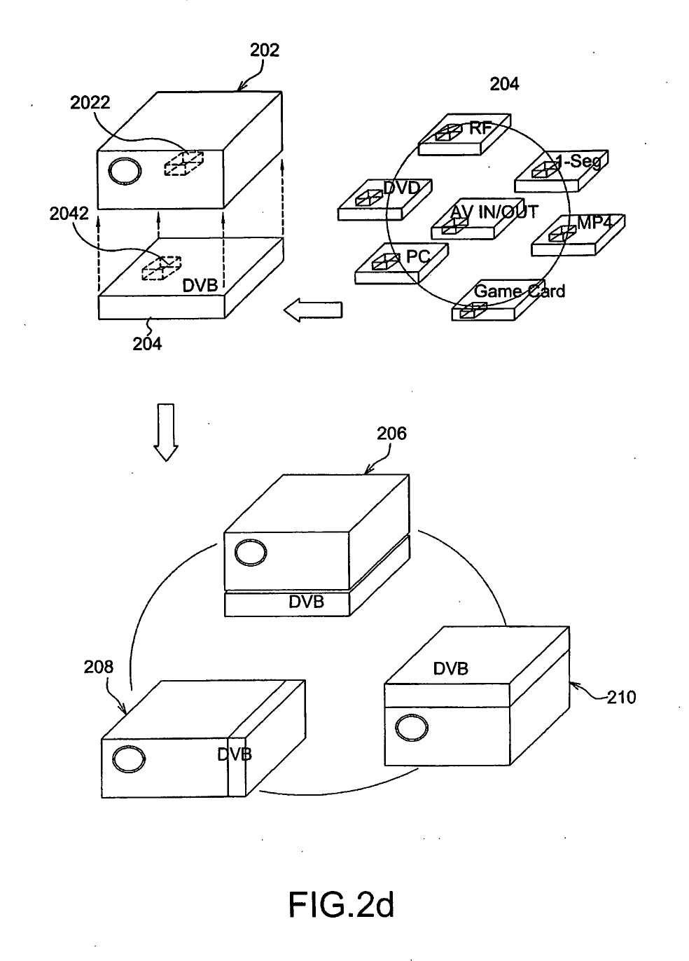

FIG. 2a is a schematic block diagram illustrating a projector according to one embodiment of the present invention. In this embodiment, the projector 100 includes a housing 102, an optical unit 104, a heat transfer module 106, a control circuit 108, a computer card adapter 110, and an insertable computer card 112. Except the computer card adapter 110 and insertable computer card 112, other components have been described above.

The computer card adapter 110 is electrically connected to the control circuit 108. And the projector 100 may project the image/video data according to the signals from the computer card 112 inserted into the computer card adapter 110. For example, the computer card 112 is implemented as a DVB computer card 112. The projector 100 may project video data according to the DVB signals from the DVB computer card 112. Particularly, the signals from the computer card 112 may be signals of the DVB-T/H, MP4, 1-Seg, RF Tx/Rx, DVD, or AV IN/OUT.

The computer card may be formed as, but not limited to, a PCMCIA card. In computing, the PCMCIA is the form factor of a peripheral interface designed for laptop computers. It was originally for memory expansion, but the existence of a usable general standard for notebook peripherals led to many kinds of devices being made available in this form.

The DVB is a suite of internationally accepted open standards for digital television. Furthermore, the DVB-T standard is for Handheld and DVB-H standard is for Terrestrial. The MP4 is a standard used primarily to compress audio and visual (AV) digital data. The 1-Seg is a mobile terrestrial digital audio/video and data broadcasting service in Japan.

Referring to the FIG. 2b and FIG. 2c, the computer card adapter 110 may be extendable outside the projector 100 via a transmission line 1102 or a wireless communication 1104. Furthermore, the signals from the computer card 112 is coupled to the control circuit 108 through the transmission line 1102 or the wireless communication 1104 from the computer card adapter 110. The wireless communication 1104 may be implemented by Bluetooth, infrared, near field communication, and radio frequency (RF).

Referring to the FIG. 2d, the projector 202 also includes a removable base 204. In this embodiment, the removable base 204 may be formed as a box, an adapter, a card, etc. Particularly, the removable base 204 includes a signal generating circuit 2042 that generates the signals independently to the project 202. And the projector 202 also includes a control circuit 2022 for processing the signals from the signal generating circuit 2042 in order to control the panel 1044 (as shown in FIG. 2a). The removable base 204 may generate the signals of DVB-T/H, MP4, 1-Seg, RF Tx/Rx, DVD, or AV IN/OUT according to the generating circuit 2042 disposed in the different removable base 204. Note that, depended on how the user sets up the projector 202, the base 204 is not always at the bottom of the projector 202. The project 202 may have many kinds of methods to be combined with the removable base 204, such as deposed at the bottom 206, by side 208, and on the top of the projector 210. Particularly, the removable base 204 provides not only the signals but also the power supply, for example, a battery cell.

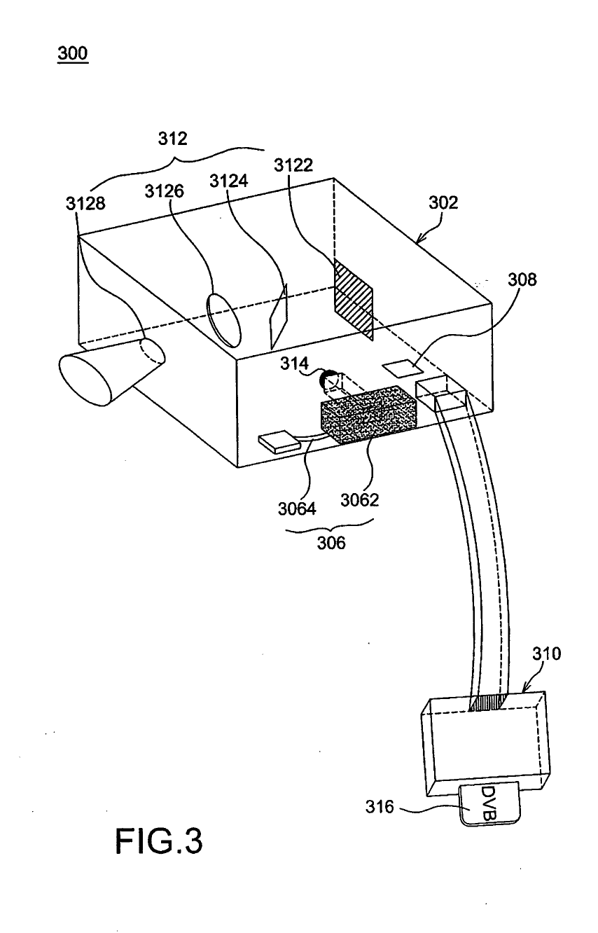

FIG. 3 is a schematic diagram illustrating a projector according to another embodiment of the present invention. In this embodiment, the projector 300 includes a housing 302, a light source 304, a heat transfer module 306, a control circuit 308, a computer card adapter 310, an insertable computer card 316 and an optical unit 312. The heat transfer module 306 includes a heat sink 3062 and a heat pipe 3064. The optical unit 312 includes a panel 3122, a polarizing beam splitter 3124, a projector lens 3126, and a window 3128.

The computer card adapter 310 adapts the computer card 316 and passes the signals from the computer card 316 to the control circuit 308. Then, the control circuit 308 processes the signals from the computer card in order to control the panel 3122. The light source 314 generates light for the panel 3122. Accordingly, the panel 3122 modulates the light provided by the light source 304. The modulated light then goes through the polarizing beam splitter 3124 and the projector lens 3126 and is projected out of the windows 3128 to form image/video for the user.

In this embodiment, the generated heat is transferred to and dissipated by the housing 302 through the heat sink 3062 and the heat pipe 3064. Preferably, due to the direct dissipation of heat by the housing, a cooling-fan is saved in the projector 300.

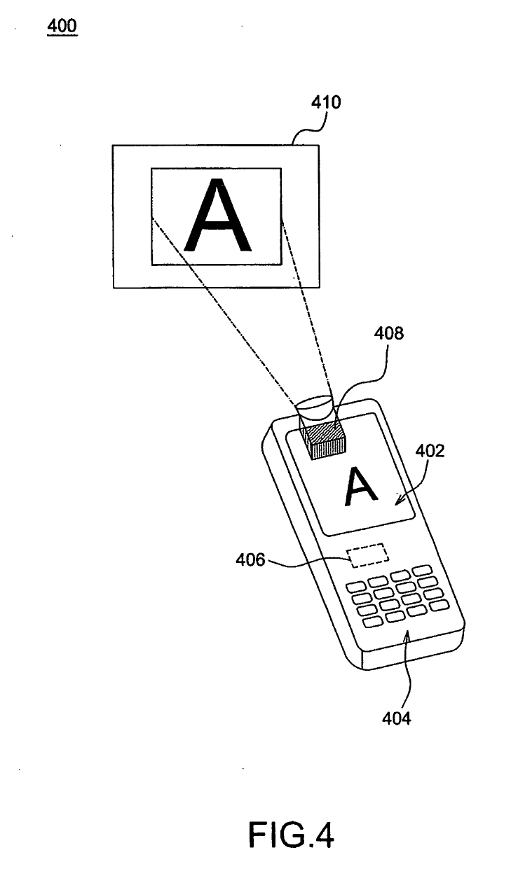

FIG. 4 is a schematic diagram illustrating a mobile device with an embedded projector according to an embodiment of the present invention. The mobile device 400 includes a built-in screen 402, an input unit 404, a communication circuit 406, and a projector 408. A user may input the data on the screen 402 via the input unit 404. Particularly, the input data is also presented to the projection screen 410 via the projector 408. The communication circuit 406 is provided for receiving/sending data from/to a remote station via wireless communication, e.g., GSM or WLAN. The control circuit 308 is electrically connected to the communication circuit 406 for controlling the panel 3122 (as shown in FIG. 3) to modulate the light in order to present the data.

Additionally, the projector 408 is a cooling-fan saved projector because the heat transfer module 306 described above is adopted to replace a conventional cooling fan. Therefore, the mobile device 400 may be effectively reduced in size and the noise generated by the conventional cooling fan is eliminated. Particularly, it may transfer the heat from light source 304 to the housing of the mobile device 400 to dissipate effectively.

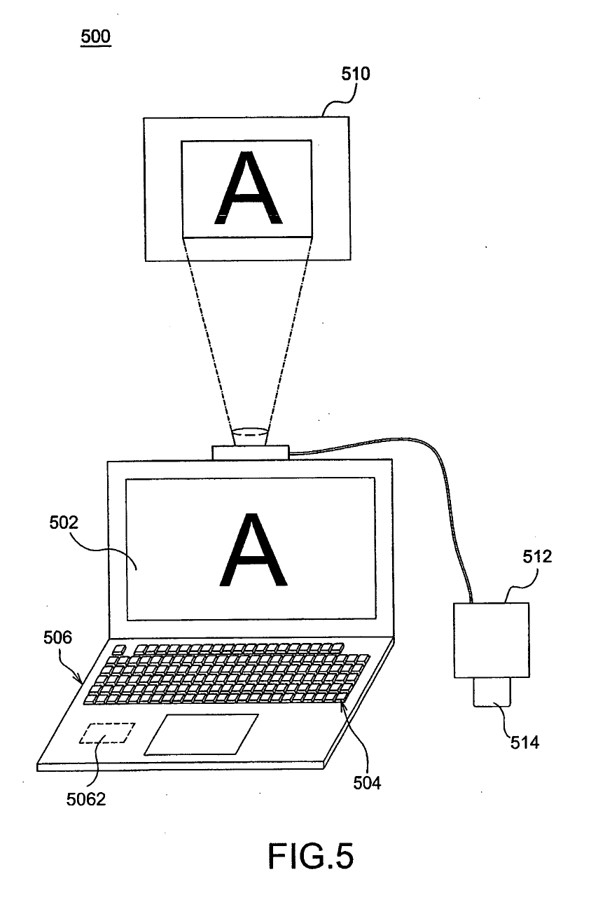

FIG. 5 is a schematic diagram illustrating a computer device with an embedded projector according to an embodiment of the present invention. The computer device 500 includes a built-in monitor 502, an input unit 504, a memory 5062, a host 506, and a projector 508. When a user input the data into the host 506 via the input unit 504, the data is stored in the memory 5062. The control circuit 308 (as shown in FIG. 3) of the projector 507 is electrically connected to the memory 5062 of the host 506, and the control circuit 308 controls the panel 3122 to modulate the light in order to present the data stored in the memory 5062. The data is presented to the projection screen 510 via the projector 517. The computer device 500 includes a computer card adapter 512 and a computer card 514. The computer card 514 is inserted into the computer card adapter 512 and the control circuit 308 further processes signals from the computer card 514. The signals from the computer card 514 may be signals of the DVB-T/H, MP4, 1-Seg, RF Tx/Rx, DVD, or AV IN/OUT.

Additionally, the projector 508 is a cooling-fan saved projector because the heat transfer module 306 described above is adopted to replace a conventional cooling fan. The computer device 500 may provide a bigger projection image and less noise will be generated. Particularly, it may transfer the heat from light source housing 304 to the housing 302 of the projector 508 to dissipate effectively.

While this invention has been described with reference to the illustrative embodiments, these descriptions should not be construed as a limit. Various modifications of the illustrative embodiment, as well as other embodiments of the invention, will be apparent upon reference to these descriptions. It is therefore contemplated that the appended claims will cover any such modifications or embodiments as falling within the true scope of the invention and its legal equivalents.

What is claimed is:

1. A projector, comprising:
a housing, made of a material with high thermal conductivity having a window;
an optical unit accommodated in said housing, comprising:
a light source for providing light;
a panel for modulating said light; and
a projection lens for projecting said modulated light to leave said window;
a heat transfer module, accommodated in said housing, for connecting said optical unit and said housing, to transfer heat from said optical unit to said housing.

2. A projector according to claim 1, wherein said projector is a cooling-fan saved projector.

3. A projector according to claim 1, said projector further comprises a computer card adapter and a computer card insertable into said computer card adapter.

4. A projector according to claim 3, wherein said computer card is a PCMCIA card.

5. A projector according to claim 3, further comprising a control circuit for processing signals of DVB-T/H, MP4, 1-Seg, RF Tx/Rx, DVD, or AV IN/OUT from said computer card in order to control said panel.

6. A projector according to claim 5, wherein said computer card adapter is connected to said control circuit via wireless.

7. A projector according to claim 1, wherein said heat transfer module connects said light source and said housing to transfer heat from said light source to said housing.

8. A projector according to claim 7, wherein said rear of said light source is connected to said heat transfer module.

9. A projector according to claim 7, wherein said bottom of said housing is connected to said heat transfer module.

10. A projector according to claim 1, wherein said heat transfer module further comprises a heat pipe.

11. A projector according to claim 1, wherein said heat transfer module further comprises a heat sink.

12. A projector according to claim 1, wherein said material with high thermal conductivity is a metal.

13. A projector according to claim 1, wherein said panel is an AMLCD.

14. A projector according to claim 1, wherein said light source is a LED, or a lamp.

15. A projector according to claim 1, said projector further comprises a removable base having a signal generating circuit, wherein said projector comprises a control circuit for processing signals of DVB-T/H, MP4, 1-Seg, RF Tx/Rx, DVD, or AV IN/OUT from said signal generating circuit in order to control said panel.

16. A mobile device, comprising:
a projector, comprising:
a housing, made of a material with high thermal conductivity having a window;
an optical unit accommodated in said housing, comprising:
a light source for providing light;
a panel for modulating said light; and
a projection lens for projecting said modulated light to leave said window
a heat transfer module, accommodated in said housing, for connecting said optical unit and said housing, to transfer heat from said optical unit to said housing;
a communication circuit for receiving data from a remote station via wireless communication; and
a control circuit, connected to said communication circuit, for controlling said panel to modulate said light in order to present said data.

17. A computer device, comprising:
a projector, comprising:
a housing, made of a material with high thermal conductivity having a window;
an optical unit accommodated in said housing, comprising:
a projection lens;
a light source for providing light;
a panel for modulating said light; and
a projection lens for projecting said modulated light to leave said window;
a heat transfer module, accommodated in said housing, for connecting said optical unit and said housing, to transfer heat from said optical unit to said housing;
a memory for storing a data input by a user; and
a control circuit, connected to said memory, for controlling said panel to modulate said light in order to present said data.

18. A computer device according to claim 17, said projector further comprises a computer card adapter and a computer card insertable into said computer card adapter, and said control circuit further processes signals of DVB-T/H, MP4, 1-Seg, RF Tx/Rx, DVD, or AV IN/OUT from said computer card.
